(19) United States
(12) Patent Application Publication
(10) Pub. No.: US 2021/0259224 A1
(43) Pub. Date: Aug. 26, 2021

(54) INTERNAL STRENGTHENING SYSTEM FOR SOFT PLASTIC FISHING LURES

(71) Applicants: John Hatfield, West Branch, IA (US); Benjamin Thompson, West Branch, IA (US)

(72) Inventors: John Hatfield, West Branch, IA (US); Benjamin Thompson, West Branch, IA (US)

(21) Appl. No.: 16/798,800

(22) Filed: Feb. 24, 2020

(51) Int. Cl. A01K 85/16; A01K 85/00

(52) U.S. Cl. CPC A01K 85/16; A01K 85/005

(57) ABSTRACT

A fishing lure having a body with a first end and a second end. Extending through the body is one or more strips of fabric that preferably extend along a length of the body. Also, embedded in the body is one or more strands that extend form the first end of the body to the second end.

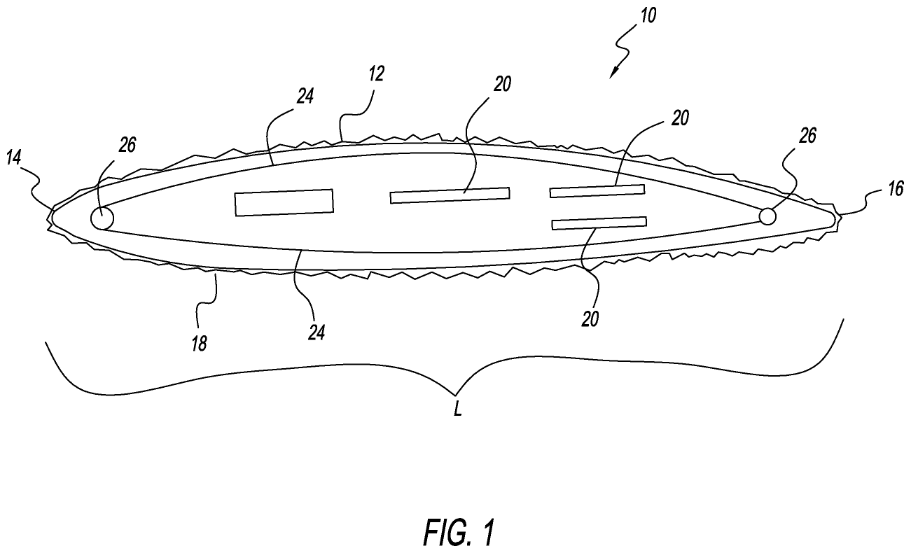

### BACKGROUND OF THE INVENTION

This invention is direction to a fishing lure, and more particularly a fishing lure with a soft plastic strengthening system.

Soft plastic fishing lures have been popular among fisherman for decades. They are usually comprised of plastisol, infused with salt and glitter to make them attractive to fish. Plastisol is comprised of PVC resin and plasticizer, which melts at low temperatures for injection molding. Typically, lures are produced by this method in tapered cylindrical molds, intended for a limited number of uses. This style of lure is designed to be hooked through the middle of the lure in what is called “wacky style.” A lure hooked in this way creates a lifelike wiggling motion in the water when pulled with quick tugging motions. This makes the lure effective for catching largemouth and smallmouth bass. The main drawback with plastisol lures used wacky style is their limited number of uses due to damage occurring on the soft flexible bodies of the lures. Accordingly, a need exists in the art for a lure that addresses these deficiencies.

Accordingly, an objective of the present invention is to provide a fishing lure that lasts longer.

Another objective of the present invention is to provide a fishing lure having a built-in strengthening system.

These and other objectives will be apparent to those skilled in the art based upon the following written description, drawings, and claims.

### SUMMARY OF THE INVENTION

A fishing lure with a strengthening system includes a body having a first end and a second end. Extending through the body is at least one or more strips of fabric that preferably extend along a length of the body. Embedded within the body is one or more strands that extend from the first end of the body to the second. Ends of the strands are bound by adhesive which forms a stop adapted to prevent the body from being pulled off the strands.

### BRIEF DESCRIPTION OF THE DRAWINGS

The FIGURE is a top sectional view of a fishing lure.

### DETAILED DESCRIPTION OF THE PREFERRED EMBODIMENTS

Referring to the FIGURE, a fishing lure 10 includes a body 12. The body 12 is of any size and shape and in one example has a tapered cylindrical shape having a first end 14 and a second end 16. The body is also made of any material and preferably is made of a soft, flexible plastisol material. Along the length of the body 12, between the ends 14 and 16, are a plurality of ribs 18 that extend around the body 12.

Extending through the body 12 and extending along a length L of the body 12 is one or more strips of fabric 20. The strips 20 are positioned anywhere along the length L of the body 12, and preferably at a midpoint of the body 12. Strips 20 are also placed in parallel relation along the length L of the body 12.

In one embodiment, in addition to the one or more strips 20, one or more strands 24 are embedded within the body and extend the length L of the body 12 from the first end 14 to the second end 16. The ends of the strands 24 are secured together and to the body 12 with adhesive 26 which forms a ball or stop preventing the body 12 from being pulled off the strands 24. The strands 24 preferably are made of Nylon and provide strength along the length L of the body 12.

In operation, a hook (not shown) is inserted through the body 12 and at least one strip 20 of fabric 20. Because the strip 20 is stronger than the body 12 the hook is more likely to stay in place as opposed to being ripped out when a fish bites.

Accordingly, a fish lure has been disclosed that at the very least meets all the stated objectives.

From the above discussion and accompanying FIGURE and claims it will be appreciated that the fishing lure 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A fishing lure, comprising:
a body having a first end and a second end; and
at least one strip of fabric that extends through the body.

2. The lure of claim 1 wherein the body is made of a plastisol material.

3. The lure of claim 1 wherein the body has a tapered cylindrical shape.

4. The lure of claim 1 wherein the at least one strip of fabric extends along a length of the body.

5. The lure of claim 1 wherein the strip of fabric is positioned at a midpoint of the body.

6. The lure of claim 1 further comprising at least two strips of fabric positioned in parallel spaced relation along a length of the body.

7. The lure of claim 1 further comprising one or more strand embedded within the body and extending from the first end to the second end.

8. The lure of claim 7 wherein ends of the strands are bound by adhesive that forms a stop.

9. A fishing lure, comprising:
a body having a first end and a second end; and
a strand embedded within the body that extends form the first end to the second end.
